(19) United States
(12) Patent Application Publication
(10) Pub. No.: US 2022/0101022 A1
(43) Pub. Date: Mar. 31, 2022

(54) VEHICLE CLIFF AND CREVASSE DETECTION SYSTEMS AND METHODS

(71) Applicant: Rivian IP Holdings, LLC, Plymouth, MI (US)

(72) Inventors: Jason Quint, Ann Arbor, MI (US); Kok Wei Koh, Mountain View, CA (US)

(21) Appl. No.: 17/036,519

(22) Filed: Sep. 29, 2020

(51) Int. Cl. G06K 9/00; B60W 50/16

(52) U.S. Cl. CPC G06K 9/00798; B60W 2050/146; B60W 50/16

(57) ABSTRACT

A system and method, utilizing: a sensor assembly coupled to a vehicle and adapted to detect a cliff or crevasse of a predetermined depth within a predetermined distance adjacent to the vehicle; and a display visible to an occupant inside the vehicle and adapted to provide an alert to the occupant when the sensor assembly detects the cliff or crevasse of the predetermined depth within the predetermined distance adjacent to the vehicle. The sensor assembly includes a sensor device coupled to a processor that are collectively adapted to detect the cliff or crevasse of the predetermined depth within the predetermined distance adjacent to the vehicle. The sensor device includes one of an ultrasonic sensor, a radar sensor, a lidar sensor, and a camera. The alert includes one or more of a visual alert, an audible alert, and a haptic alert.

### TECHNICAL FIELD

The present disclosure relates generally to the automotive field. More particularly, the present disclosure relates to vehicle cliff and crevasse detection systems and methods.

### BACKGROUND

Two of the many hazards that a vehicle operator may encounter when driving off-road are cliffs and crevasses. If the operator drives his or her vehicle off a cliff or into a crevasse, he or she may be injured and/or damage the vehicle. Likewise, the operator may be injured if he or she exits the vehicle and steps off a cliff or into a crevasse. Such hazards are often difficult to see and/or judge, and operator inattention may exacerbate this problem. Many vehicles are equipped with advanced driver assistance systems (ADASs) that detect and alert operators to various on-road hazards, not currently including cliffs and crevasses. In fact, such ADASs are not generally adapted to deal with off-road hazards at all.

This background is provided as an illustrative contextual environment only. It will be readily apparent to those of ordinary skill in the art that the systems and methods of the present disclosure may be implemented in other contextual environments as well.

### SUMMARY

In one illustrative embodiment, the present disclosure provides a system, including: a sensor assembly coupled to a vehicle and adapted to detect a cliff or crevasse of a predetermined depth adjacent to the vehicle; and a display visible to an occupant inside the vehicle and adapted to provide an alert to the occupant when the sensor assembly detects the cliff or crevasse of the predetermined depth adjacent to the vehicle. The sensor assembly includes a sensor device coupled to a processor that are collectively adapted to detect the cliff or crevasse of the predetermined depth adjacent to the vehicle. The sensor device includes one of an ultrasonic sensor, a radar sensor, a lidar sensor, and a camera. In an illustrative embodiment, the sensor device includes one or more of a front-facing perception sensor, a rear-facing perception sensor, and a side-facing perception sensor coupled to the processor and collectively adapted to segment an obtained image of surroundings of the vehicle to detect presence and absence of a ground plane adjacent to the vehicle. In an illustrative embodiment, the one or more of the front-facing perception sensor, the rear-facing perception sensor, and the side-facing perception sensor and the processor are collectively adapted to segment the obtained image of the surroundings of the vehicle to detect the presence and absence of the ground plane adjacent to the vehicle using a neural network applying a statistical technique. Alternatively, in another illustrative embodiment, the one or more of the front-facing perception sensor, the rear-facing perception sensor, and the side-facing perception sensor and the processor are collectively adapted to segment the obtained image of the surroundings of the vehicle to detect the presence and absence of the ground plane adjacent to the vehicle using a machine learning algorithm trained using a set of training images. In a further illustrative embodiment, the sensor device includes a proximity sensor coupled to a door of the vehicle and, with the processor, is adapted to detect presence and absence of a ground plane adjacent to the vehicle when the door is opened by the occupant. The alert includes one or more of a visual alert, an audible alert, and a haptic alert.

In another illustrative embodiment, the present disclosure provides a method, including: detecting a cliff or crevasse of a predetermined depth adjacent to a vehicle using a sensor assembly coupled to the vehicle; and providing an alert to an occupant inside the vehicle when the sensor assembly detects the cliff or crevasse of the predetermined depth adjacent to the vehicle using a display visible to the occupant. The sensor assembly includes a sensor device coupled to a processor that are collectively adapted to detect the cliff or crevasse of the predetermined depth adjacent to the vehicle. The sensor device includes one of an ultrasonic sensor, a radar sensor, a lidar sensor, and a camera. In an illustrative embodiment, the sensor device includes one or more of a front-facing perception sensor, a rear-facing perception sensor, and a side-facing perception sensor coupled to the processor and collectively adapted to segment an obtained image of surroundings of the vehicle to detect presence and absence of a ground plane adjacent to the vehicle. In an illustrative embodiment, the one or more of the front-facing perception sensor, the rear-facing perception sensor, and the side-facing perception sensor and the processor are collectively adapted to segment the obtained image of the surroundings of the vehicle to detect the presence and absence of the ground plane adjacent to the vehicle using a neural network applying a statistical technique. Alternatively, in another illustrative embodiment, the one or more of the front-facing perception sensor, the rear-facing perception sensor, and the side-facing perception sensor and the processor are collectively adapted to segment the obtained image of the surroundings of the vehicle to detect the presence and absence of the ground plane adjacent to the vehicle using a machine learning algorithm trained using a set of training images. In a further illustrative embodiment, the sensor device includes a proximity sensor coupled to a door of the vehicle and, with the processor, is adapted to detect presence and absence of a ground plane adjacent to the vehicle when the door is opened by the occupant. The alert includes one or more of a visual alert, an audible alert, and a haptic alert.

In a further illustrative embodiment, the present disclosure provides a display including an visual alert icon visible to an occupant inside a vehicle and adapted to provide an alert to the occupant when a sensor assembly coupled to the vehicle detects a cliff or crevasse of a predetermined depth adjacent to the vehicle. The sensor assembly includes a sensor device coupled to a processor that are collectively adapted to detect the cliff or crevasse of the predetermined depth adjacent to the vehicle. In an illustrative embodiment, the visual alert icon is accompanied by an audible alert signal. In another illustrative embodiment, the visual alert icon is accompanied by a haptic alert movement.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram of one illustrative embodiment of the cliff and crevasse detection system and method of the present disclosure;

FIG. 2 is an illustrative (vehicle-in-motion) instrument panel display of the cliff and crevasse detection system and method of the present disclosure;

FIG. 3 is an illustrative (vehicle egress) instrument panel display of the cliff and crevasse detection system and method of the present disclosure;

FIG. 4 is a network diagram of a cloud-based system for implementing various cloud-based functions of the present disclosure;

FIG. 5 is a block diagram of a server which may be used in the cloud-based system of FIG. 4 or stand-alone; and

FIG. 6 is a block diagram of a user device which may be used in the cloud-based system of FIG. 4 or stand-alone.

### DESCRIPTION OF ILLUSTRATIVE EMBODIMENTS

In general, the vehicle cliff and crevasse detection system and method of the present disclosure are operable for providing both vehicle-in-motion cliff and crevasse detection and vehicle egress cliff and crevasse detection. In the former case, the sensor and/or camera systems of the vehicle detect a cliff or crevasse (i.e., a sudden and substantial drop-off in the ground plane) in front of, behind, and/or to a side of the vehicle and notify the vehicle operator via an alert message displayed on an instrument panel or other display within or associated with the vehicle, and/or via a mobile device. In the latter case, the sensor and/or camera systems of the vehicle detect a cliff or crevasse (i.e., a sudden and substantial drop-off in the ground plane) to the side of the vehicle as the vehicle operator or a vehicle passenger (in a first, second, or third row of the vehicle) opens a door of the vehicle and goes to exit and again notify the operator or passenger via an alert message displayed on an instrument panel or other display within or associated with the vehicle, and/or via a mobile device. Other visual, audible, and/or haptic alerts may accompany the display.

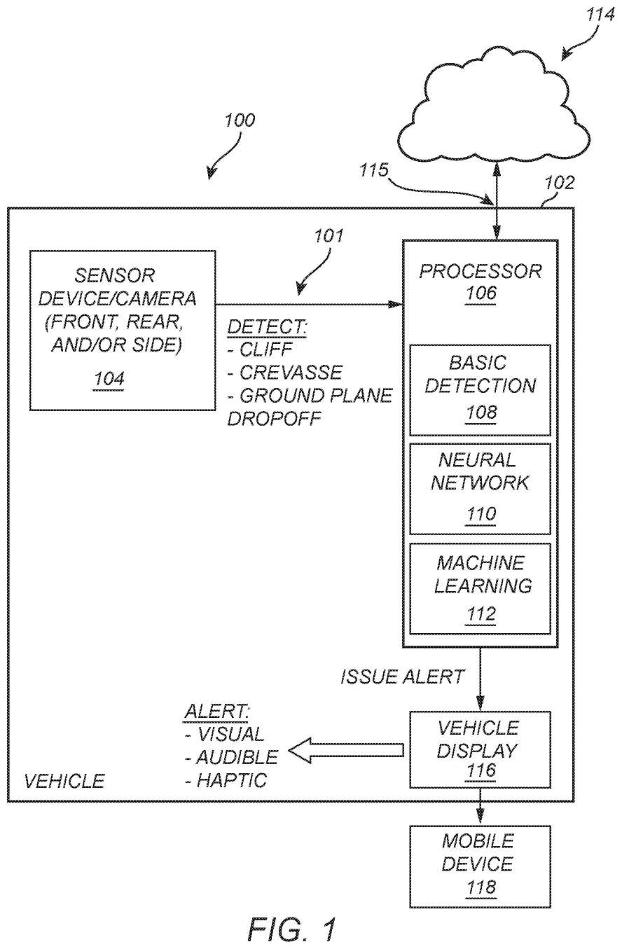

Referring now specifically to FIG. 1, in one illustrative embodiment, the cliff and crevasse detection system 100 of the present disclosure includes a sensor assembly 101 coupled to a vehicle 102 and adapted to detect a cliff or crevasse of a predetermined depth within a predetermined distance adjacent to the vehicle 102. The sensor assembly 101 includes a sensor device 104 coupled to a processor 106 that are collectively adapted to detect the cliff or crevasse of the predetermined depth within the predetermined distance adjacent to the vehicle 102. The sensor device 104 includes one or more of an ultrasonic sensor, a radar sensor, a lidar sensor, and a camera. In one illustrative embodiment, the speed or velocity of the vehicle 102 and the position and/or distance of the vehicle 102 relative to the cliff or crevasse may be used to calculate a time to impact or time to intersection. If the calculated time is below a predetermined threshold time, an appropriate alert may be triggered.

In an illustrative embodiment, the sensor device 104 includes one or more of a front-facing proximity sensor, a rear-facing proximity sensor, and a side-facing proximity sensor coupled to the processor 106 and collectively adapted to detect the simple presence or absence of a ground plane within a predetermined distance of the vehicle 102. Here, the processor 106 executes a basic detection algorithm 108 to detect the simple presence or absence of the ground plane within the predetermined distance of the vehicle 102. The proximity sensor device(s) 104 benefit from simplicity and accuracy, but have limited range, of perhaps a few meters.

In another illustrative embodiment, the sensor device 104 includes one or more of a front-facing perception sensor, a rear-facing perception sensor, and a side-facing perception sensor coupled to the processor 106 and collectively adapted to segment an obtained image of surroundings of the vehicle 102 (e.g., a lidar point cloud or camera image) to detect the presence or absence of the ground plane adjacent to the vehicle 102. This may be done before or after converting the obtained image from a “fisheye” view to a planar view, converting the obtained image from a directional view to a 360-degree “bird's eye” view (BEV), etc. In an illustrative embodiment, the one or more of the front-facing perception sensor, the rear-facing perception sensor, and the side-facing perception sensor and the processor 106 are collectively adapted to segment the obtained image of the surroundings of the vehicle 102 to detect the presence or absence of the ground plane adjacent to the vehicle 102 using a neural network (NN) algorithm 110 applying a statistical technique. Alternatively, in another illustrative embodiment, the one or more of the front-facing perception sensor, the rear-facing perception sensor, and the side-facing perception sensor and the processor 106 are collectively adapted to segment the obtained image of the surroundings of the vehicle 102 to detect the presence or absence of the ground plane adjacent to the vehicle 102 using a machine learning (ML) algorithm 112 trained using a set of training images, whether supervised or unsupervised. The perception sensor device(s) 104 benefit from extended range, but increase computational complexity. Here, radar provides a limited range, while lidar provides an extended range. Cameras are beneficial in terms of range (perhaps tens or hundreds of meters), but may sacrifice accuracy in inclement weather and other limited-visibility conditions.

In a further illustrative embodiment, the sensor device 104 includes a proximity sensor coupled to a door (or other side structure) of the vehicle 102 and, with the processor 106, is adapted to detect presence or absence of the ground plane adjacent to the vehicle 102 when the door is opened by the occupant. This proximity sensor may be generally downwards facing. Again, the proximity sensor device 104 benefits from simplicity and accuracy, but has limited range, of perhaps a few meters.

The threshold applied to determine that a cliff or crevasse is in the proximity of the vehicle 102 may be selected by the vehicle operator or system manufacturer and will typically involve a ground plane drop that could cause damage to the vehicle 102 and/or injury to the operator if it was to be traversed by the vehicle 102 or encountered by the operator. For example, a threshold on the order of feet or meters may be selected and utilized by the processor 106. Similarly, the proximity of the cliff or crevasse to the vehicle 102 may also be thresholded. For example, an alert may be triggered if a cliff or crevasse is detected tens or hundreds of meters in front of the vehicle 102, especially if the vehicle 102 is traveling at a high known rate of speed, as this creates and imminent travel risk, while an alert may be triggered if a cliff or crevasse is detected immediately next to the vehicle 102, as this creates an imminent egress risk. These distances may be assessed using any known ranging methodology generally directed to assessing object and obstacle distances.

In addition to receiving input from the one or more sensor devices 104, the processor 106 may obtain topographic information from the cloud 114 via a vehicle communications link 115. In combination with vehicle global positioning system (GPS) data, this topographic information may assist the vehicle 102 in assessing its proximity to a cliff or crevasse. Detected cliff and crevasse information may also be transmitted from the vehicle 102 to the cloud 114 for use in subsequent trips and/or by other vehicles 102. In this manner, vehicles 102 may be used to generate subsequent topographic information that is refined for off-road areas on an ongoing basis.

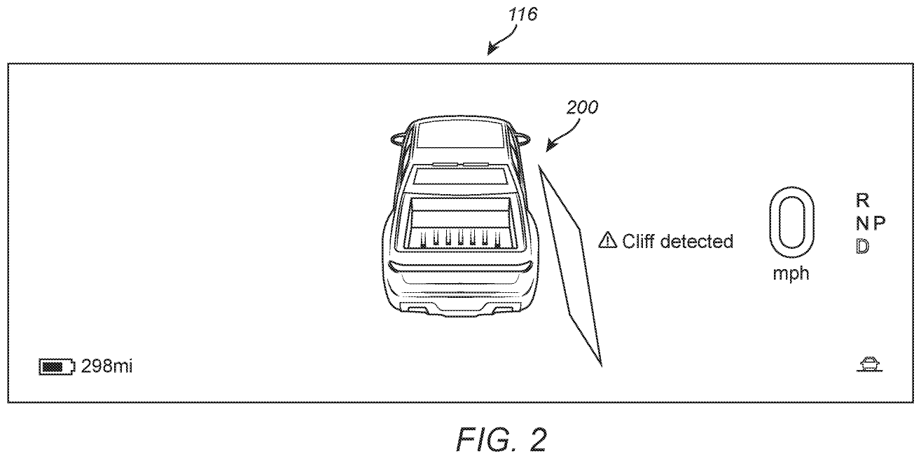

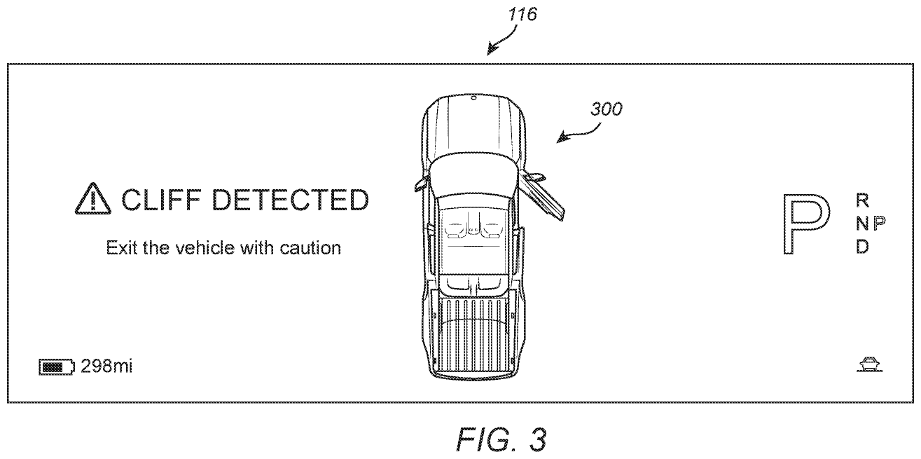

Once a cliff or crevasse is detect by the processor 106, an instrument panel display 116 (or the like) including a visual alert icon 200 (FIG. 2), 300 (FIG. 3) visible to an occupant inside the vehicle 102 is used to provide an appropriate alert to the occupant. Here, the alert may be visual, audible, and/or haptic. For example, the alert may include a displayed message, a displayed graphic, a flashing light, a warning sound, a steering wheel vibration, etc. The degree of such alert may increase with the determined depth of a cliff or crevasse, its proximity to the vehicle, etc., thereby getting the attention of an out-of-the-loop or distracted operator or occupant that does not heed an initial alert.

FIG. 2 is an illustrative (vehicle-in-motion) instrument panel display 116 of the cliff and crevasse detection system 100 (FIG. 1) of the present disclosure. Here, the visual alert icon 200 is displayed when the vehicle 102 (FIG. 1) is in “drive” (or rolling in “neutral”). The visual alert icon 200 shows the vehicle 102 in a perspective view and shows a relative location of the detected cliff or crevasse along with a warning message—“cliff detected.” A BEV could be displayed equally.

FIG. 3 is an illustrative (vehicle egress) instrument panel display 116 of the cliff and crevasse detection system 100 (FIG. 1) of the present disclosure. Here, the visual alert icon 300 is displayed when the vehicle 102 (FIG. 1) is in “neutral” or “park”. The visual alert icon 300 shows the vehicle 102 in a BEV and shows a relative location of the detected cliff or crevasse along with a warning message—“cliff detected, exit the vehicle with caution.” A perspective view could be displayed equally.

As alluded to above, an alert message may also be provided via a user's mobile device 118 (FIG. 1) and/or shared on a vehicle-to-vehicle (V2V) or vehicle-to-infrastructure (V2I) basis.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

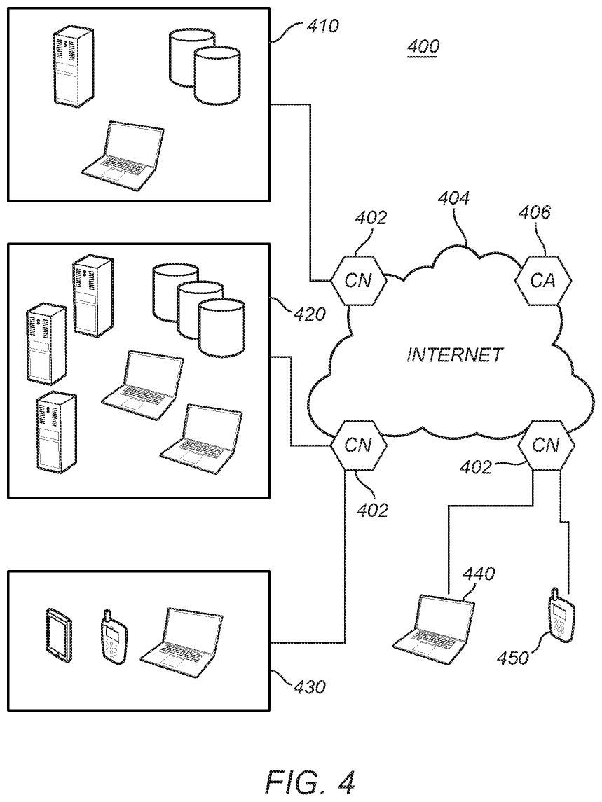

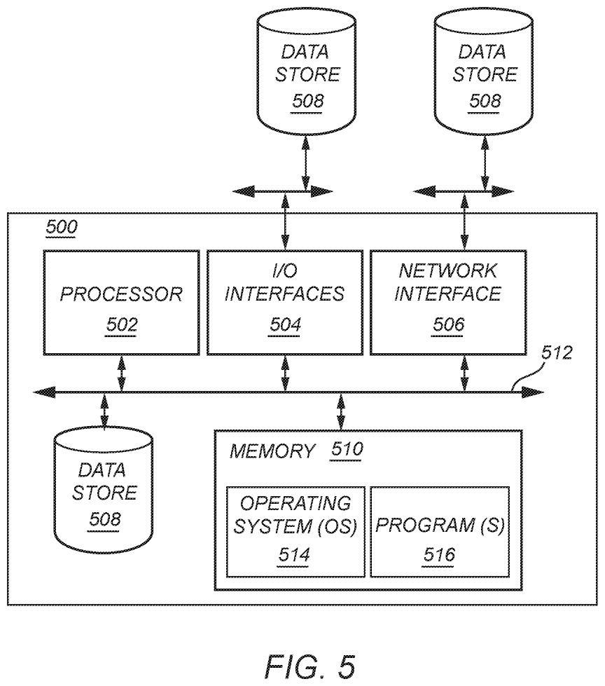

FIG. 4 is a network diagram of a cloud-based system 400 for implementing various cloud-based services of the present disclosure. The cloud-based system 400 includes one or more cloud nodes (CNs) 402 communicatively coupled to the Internet 404 or the like. The cloud nodes 402 may be implemented as a server 500 (as illustrated in FIG. 5) or the like and can be geographically diverse from one another, such as located at various data centers around the country or globe. Further, the cloud-based system 400 can include one or more central authority (CA) nodes 406, which similarly can be implemented as the server 500 and be connected to the CNs 402. For illustration purposes, the cloud-based system 400 can connect to a regional office 410, headquarters 420, various employee's homes 430, laptops/desktops 440, and mobile devices 450, each of which can be communicatively coupled to one of the CNs 402. These locations 410, 420, and 640, and devices 440 and 450 are shown for illustrative purposes, and those skilled in the art will recognize there are various access scenarios to the cloud-based system 400, all of which are contemplated herein. The devices 440 and 450 can be so-called road warriors, i.e., users off-site, on-the-road, etc. The cloud-based system 400 can be a private cloud, a public cloud, a combination of a private cloud and a public cloud (hybrid cloud), or the like.

Again, the cloud-based system 400 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 410, 420, and 430 and devices 440 and 450. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 400 is replacing the conventional deployment model. The cloud-based system 400 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 400 is illustrated herein as one example embodiment of a cloud-based system, and those of ordinary skill in the art will recognize the systems and methods described herein are not necessarily limited thereby.

FIG. 5 is a block diagram of a server 500, which may be used in the cloud-based system 400 (FIG. 4), in other systems, or stand-alone. For example, the CNs 402 (FIG. 4) and the central authority nodes 406 (FIG. 4) may be formed as one or more of the servers 500. The server 500 may be a digital computer that, in terms of hardware architecture, generally includes a processor 502, input/output (I/O) interfaces 504, a network interface 506, a data store 508, and memory 510. It should be appreciated by those of ordinary skill in the art that FIG. 5 depicts the server 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 may be, for example, but is not limited to, one or more buses or other wired or wireless connections, as is known in the art. The local interface 512 may have additional elements, which are omitted for simplicity, such as controllers, buffers (caches), drivers, repeaters, and receivers, among many others, to enable communications. Further, the local interface 512 may include address, control, and/or data connections to enable appropriate communications among the aforementioned components.

The processor 502 is a hardware device for executing software instructions. The processor 502 may be any custom made or commercially available processor, a central processing unit (CPU), an auxiliary processor among several processors associated with the server 500, a semiconductor-based microprocessor (in the form of a microchip or chipset), or generally any device for executing software instructions. When the server 500 is in operation, the processor 502 is configured to execute software stored within the memory 510, to communicate data to and from the memory 510, and to generally control operations of the server 500 pursuant to the software instructions. The I/O interfaces 504 may be used to receive user input from and/or for providing system output to one or more devices or components.

The network interface 506 may be used to enable the server 500 to communicate on a network, such as the Internet 404 (FIG. 4). The network interface 506 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 506 may include address, control, and/or data connections to enable appropriate communications on the network. A data store 508 may be used to store data. The data store 508 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 508 may incorporate electronic, magnetic, optical, and/or other types of storage media. In one example, the data store 508 may be located internal to the server 500, such as, for example, an internal hard drive connected to the local interface 512 in the server 500. Additionally, in another embodiment, the data store 508 may be located external to the server 500 such as, for example, an external hard drive connected to the I/O interfaces 504 (e.g., a SCSI or USB connection). In a further embodiment, the data store 508 may be connected to the server 500 through a network, such as, for example, a network-attached file server.

The memory 510 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 510 may have a distributed architecture, where various components are situated remotely from one another but can be accessed by the processor 502. The software in memory 510 may include one or more software programs, each of which includes an ordered listing of executable instructions for implementing logical functions. The software in the memory 510 includes a suitable operating system (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

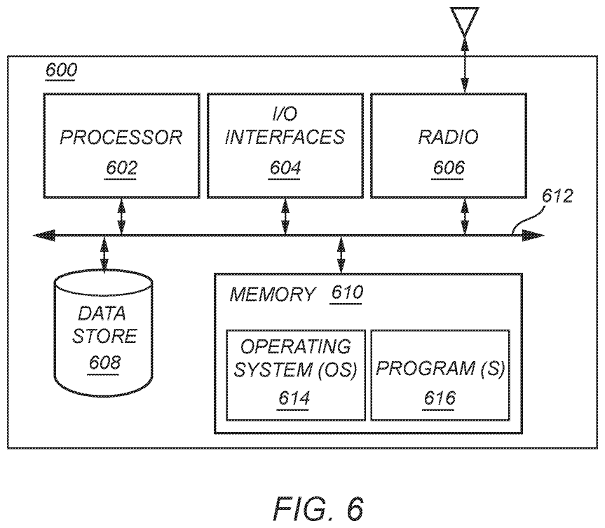

FIG. 6 is a block diagram of a user device 600, which may be used in the cloud-based system 400 (FIG. 4), as part of a network, or stand-alone. Again, the user device 600 can be a vehicle, a smartphone, a tablet, a smartwatch, an Internet of Things (IoT) device, a laptop, a virtual reality (VR) headset, etc. The user device 600 can be a digital device that, in terms of hardware architecture, generally includes a processor 602, I/O interfaces 604, a radio 606, a data store 608, and memory 610. It should be appreciated by those of ordinary skill in the art that FIG. 6 depicts the user device 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 can be, for example, but is not limited to, one or more buses or other wired or wireless connections, as is known in the art. The local interface 612 can have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 can be any custom made or commercially available processor, a CPU, an auxiliary processor among several processors associated with the user device 600, a semiconductor-based microprocessor (in the form of a microchip or chipset), or generally any device for executing software instructions. When the user device 600 is in operation, the processor 602 is configured to execute software stored within the memory 610, to communicate data to and from the memory 610, and to generally control operations of the user device 600 pursuant to the software instructions. In an embodiment, the processor 602 may include a mobile optimized processor such as optimized for power consumption and mobile applications. The I/O interfaces 604 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 606 enables wireless communication to an external access device or network. Any number of suitable wireless data communication protocols, techniques, or methodologies can be supported by the radio 606, including any protocols for wireless communication. The data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 610 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 610 may incorporate electronic, magnetic, optical, and/or other types of storage media. Note that the memory 610 may have a distributed architecture, where various components are situated remotely from one another, but can be accessed by the processor 602. The software in memory 610 can include one or more software programs, each of which includes an ordered listing of executable instructions for implementing logical functions. In the example of FIG. 6, the software in the memory 610 includes a suitable operating system 614 and programs 616. The operating system 614 essentially controls the execution of other computer programs and provides scheduling, input-output control, file and data management, memory management, and communication control and related services. The programs 616 may include various applications, add-ons, etc. configured to provide end user functionality with the user device 600. For example, example programs 616 may include, but not limited to, a web browser, social networking applications, streaming media applications, games, mapping and location applications, electronic mail applications, financial applications, and the like. In a typical example, the end-user typically uses one or more of the programs 616 along with a network, such as the cloud-based system 400 (FIG. 4).

Thus, in general, the vehicle cliff and crevasse detection system and method of the present disclosure are operable for providing both vehicle-in-motion cliff and crevasse detection and vehicle egress cliff and crevasse detection. In the former case, the sensor and/or camera systems of the vehicle detect a cliff or crevasse (i.e., a sudden and substantial drop-off in the ground plane) in front of, behind, and/or to a side of the vehicle and notify the vehicle operator via an alert message displayed on an instrument panel or other display within or associated with the vehicle, and/or via a mobile device. In the latter case, the sensor and/or camera systems of the vehicle detect a cliff or crevasse (i.e., a sudden and substantial drop-off in the ground plane) to the side of the vehicle as the vehicle operator opens a door of the vehicle and goes to exit and again notify the operator via an alert message displayed on an instrument panel or other display within or associated with the vehicle, and/or via a mobile device. Other visual, audible, and/or haptic alerts may accompany the display.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A system, comprising:
a sensor assembly coupled to a vehicle and adapted to detect a cliff or crevasse of a predetermined depth within a predetermined distance adjacent to the vehicle; and
a display visible to an occupant inside the vehicle and adapted to provide an alert to the occupant when the sensor assembly detects the cliff or crevasse of the predetermined depth within the predetermined distance adjacent to the vehicle.

2. The system of claim 1, wherein the sensor assembly comprises a sensor device coupled to a processor that are collectively adapted to detect the cliff or crevasse of the predetermined depth within the predetermined distance adjacent to the vehicle.

3. The system of claim 2, wherein the sensor device comprises one of an ultrasonic sensor, a radar sensor, a lidar sensor, and a camera.

4. The system of claim 2, wherein the sensor device comprises one or more of a front-facing perception sensor, a rear-facing perception sensor, and a side-facing perception sensor coupled to the processor and collectively adapted to segment an obtained image of surroundings of the vehicle to detect presence and absence of a ground plane within the predetermined distance adjacent to the vehicle.

5. The system of claim 4, wherein the one or more of the front-facing perception sensor, the rear-facing perception sensor, and the side-facing perception sensor and the processor are collectively adapted to segment the obtained image of the surroundings of the vehicle to detect the presence and absence of the ground plane within the predetermined distance adjacent to the vehicle using a neural network applying a statistical technique.

6. The system of claim 4, wherein the one or more of the front-facing perception sensor, the rear-facing perception sensor, and the side-facing perception sensor and the processor are collectively adapted to segment the obtained image of the surroundings of the vehicle to detect the presence and absence of the ground plane within the predetermined distance adjacent to the vehicle using a machine learning algorithm trained using a set of training images.

7. The system of claim 2, wherein the sensor device comprises a proximity sensor coupled to a door of the vehicle and, with the processor, is adapted to detect presence and absence of a ground plane within the predetermined distance adjacent to the vehicle when the door is opened by the occupant.

8. The system of claim 1, wherein the alert comprises one or more of a visual alert, an audible alert, and a haptic alert.

9. A method, comprising:
detecting a cliff or crevasse of a predetermined depth within a predetermined distance adjacent to a vehicle using a sensor assembly coupled to the vehicle; and
providing an alert to an occupant inside the vehicle when the sensor assembly detects the cliff or crevasse of the predetermined depth within the predetermined distance adjacent to the vehicle using a display visible to the occupant.

10. The method of claim 9, wherein the sensor assembly comprises a sensor device coupled to a processor that are collectively adapted to detect the cliff or crevasse of the predetermined depth within the predetermined distance adjacent to the vehicle.

11. The method of claim 10, wherein the sensor device comprises one of an ultrasonic sensor, a radar sensor, a lidar sensor, and a camera.

12. The method of claim 10, wherein the sensor device comprises one or more of a front-facing perception sensor, a rear-facing perception sensor, and a side-facing perception sensor coupled to the processor and collectively adapted to segment an obtained image of surroundings of the vehicle to detect presence and absence of a ground plane within the predetermined distance adjacent to the vehicle.

13. The method of claim 12, wherein the one or more of the front-facing perception sensor, the rear-facing perception sensor, and the side-facing perception sensor and the processor are collectively adapted to segment the obtained image of the surroundings of the vehicle to detect the presence and absence of the ground plane within the predetermined distance adjacent to the vehicle using a neural network applying a statistical technique.

14. The method of claim 12, wherein the one or more of the front-facing perception sensor, the rear-facing perception sensor, and the side-facing perception sensor and the processor are collectively adapted to segment the obtained image of the surroundings of the vehicle to detect the presence and absence of the ground plane within the predetermined distance adjacent to the vehicle using a machine learning algorithm trained using a set of training images.

15. The method of claim 10, wherein the sensor device comprises a proximity sensor coupled to a door of the vehicle and, with the processor, is adapted to detect presence and absence of a ground plane within the predetermined distance adjacent to the vehicle when the door is opened by the occupant.

16. The method of claim 9, wherein the alert comprises one or more of a visual alert, an audible alert, and a haptic alert.

17. The method of claim 9, further comprising detecting the cliff or crevasse of the predetermined depth within the predetermined distance adjacent to the vehicle using a topographic database stored in or communicated to the vehicle and a global positioning system associated with the vehicle.

18. A display comprising a visual alert icon visible to an occupant inside a vehicle and adapted to provide an alert to the occupant when a sensor assembly coupled to the vehicle detects a cliff or crevasse of a predetermined depth within a predetermined distance adjacent to the vehicle.

19. The display of claim 17, wherein the sensor assembly comprises a sensor device coupled to a processor that are collectively adapted to detect the cliff or crevasse of the predetermined depth within the predetermined distance adjacent to the vehicle.

20. The display of claim 17, wherein the visual alert icon is accompanied by one or more of an audible alert signal and a haptic alert movement.
